(19) United States
(12) Patent Application Publication
(10) Pub. No.: US 2006/0035593 A1
(43) Pub. Date: Feb. 16, 2006

(54) Noise and interference reduction in digitized signals

(75) Inventor: David S. Leeds, Lake Worth, FL (US)

Correspondence Address: POSZ LAW GROUP, PLC, 12040 SOUTH LAKES DRIVE, SUITE 101, RESTON, VA, 20191, US

(73) Assignee: MOTOROLA, INC.

(21) Appl. No.: 10/916,806

(22) Filed: Aug. 12, 2004

(51) Int. Cl. H04B 17/00

(52) U.S. Cl. 455/67.13

(57) ABSTRACT

A method (700, 800, 900) and apparatus (1000, 1100) increase a signal quality by analyzing an input signal and output signals from adaptive filters (410, 510, 512, 514) associated with predetermined signal plus noise plus interference classifications. An actual signal plus noise plus interference classification of the input signal is determined and one of the output signals or the input signal is selected based on a favorable Signal to Noise Ratio or a Signal to Interference plus Noise Ratio. The output signals from the adaptive filters are weighted based on analysis such as statistical analysis (310) including quantified auto-regressive analysis, Eigenvalue spread analysis, correlation analysis, feedback analysis, and covariance analysis. The predetermined classifications include various combinations of characteristics associated with the signal and interference components. The adaptive filters include multi-band and single band Adaptive Noise Canceling filters (312, 314), and multi-band and single band Adaptive Line Enhancing filters (316, 318).

### FIELD OF THE INVENTION

The present invention relates in general to digital signal processing, and more specifically to a method and apparatus for increasing Signal to Interference-plus-Noise Ratio (SINR) for digitized signals such as speech signals.

### BACKGROUND OF THE INVENTION

In order to transmit signals which originate as analog signals, such as speech or voice signals, within a digital network, the analog signals must be digitized in one of many conventional ways such as through an Analog to Digital converter. Typically, once digital samples are produced through conversion, a variety of digital processing and encoding can be performed to accomplish various objectives which usually relate to reducing the actual amount of data that must be transmitted and received in a communications system while maintaining a specified minimum audio quality. Speech encoders and decoders, or parametric vocoders as they are known and commonly referred to in the art, are typically used to analyze speech samples and generate encoded output according to various standardized or proprietary protocols. As is also well understood by those of ordinary skill in the art, noise and interference are problems affecting the quality of signal processing and can affect the ability of actual signal information to be accurately analyzed and synthesized.

In a typical telecommunication system, such as a wireless communication system or the like, vocoders are used extensively to compress and otherwise reduce the amount of data required to reconstruct voice signals through synthesis as is well known. In vocoders, the Signal to Noise Ratio (SNR), or Signal to Interference plus Noise Ratio (SINR) can affect the initial analysis stage by causing errors associated with, for example, the synthesis in the vocoder.

Sources of signal, noise, and interference may vary and may include periodic sources, Gaussian noise sources, or mixed periodic+noise sources. Practical examples of various signal sources include: speech, DTMF tones, call progress tones, signaling tones, music, single tones, and the like. Interference sources can include: speech (crosstalk), music, colored or band-limited noise, automotive noise, motors, periodic noise (tones, beeps, whistles, and the like), burst noise (thuds, whacks, and the like). A typical noise source includes Additive White Gaussian Noise (AWGN) such as may originate at Public Switched Telephone Network (PSTN) switches, or such as may be due to transcoding.

Prevalent scenarios commonly encountered in real applications include situations where both the signal and the interference are permutations of periodic, mixed periodic plus noise, and straight noise. Situations where both the signal and the interference are mixed periodic signals plus noise are known to be the most difficult cases to correct for.

Problems arise however, in that it is difficult without a priori knowledge of the content of the signal to properly characterize the nature of the signal and noise component resulting in an increased probability of error while encoding, for example, within a parametric vocoder. Such error leads to synthesis error and poor speech reconstruction, poor audio quality, and difficult perceptability.

Therefore, to address the above described problems and other problems, what is needed is a method and apparatus for increasing the SINR and thus promoting better performance in devices such as vocoders, signal processors, digitizers, and the like.

### BRIEF DESCRIPTION OF THE DRAWINGS

The accompanying figures, where like reference numerals refer to identical or functionally similar elements and which together with the detailed description below are incorporated in and form part of the specification, serve to further illustrate a preferred embodiment and to explain various principles and advantages in accordance with the present invention.

FIG. 1 is a diagram illustrating a simplified and representative conventional vocoder;

FIG. 2 is a block diagram illustrating an exemplary communication unit and an exemplary infrastructure unit in which elements are arranged for increasing SNR and SINR in accordance with various exemplary embodiments;

FIG. 3 is a block diagram illustrating elements of an exemplary apparatus arranged to perform processing associated with a signal input and adaptive filter outputs in accordance with various exemplary embodiments;

FIG. 4 is a diagram illustrating an exemplary single band adaptive filter in accordance with various exemplary embodiments;

FIG. 5 is a diagram illustrating an exemplary multi-band adaptive filter in accordance with various exemplary embodiments;

FIG. 6 is a diagram illustrating an exemplary Adaptive Noise Canceller (ANC) and an exemplary Adaptive Line Enhancer (ALE) and exemplary output graphs in accordance with various exemplary embodiments;

FIG. 7 is a flow chart illustrating an exemplary procedure associated with signal processing in accordance with various exemplary and alternative exemplary embodiments;

FIG. 8 is a flow chart illustrating an exemplary procedure associated with statistical analysis in accordance with various exemplary and alternative exemplary embodiments;

FIG. 9 is a flow chart illustrating an exemplary procedure associated with decision logic in accordance with various exemplary and alternative exemplary embodiments;

FIG. 10 is a diagram illustrating an exemplary apparatus in accordance with various exemplary and alternative exemplary embodiments; and

FIG. 11 is a diagram illustrating an exemplary Digital Signal Processor (DSP) in accordance with various exemplary and alternative exemplary embodiments.

### DETAILED DESCRIPTION OF THE PREFERRED EMBODIMENTS

In overview, the present disclosure concerns digital signal processing in communication units, infrastructure units, or systems such as communications networks, and the like, employing voice coders, or vocoders, and, in particular, parametric vocoders.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions.

Much of the inventive functionality and many of the inventive principles when implemented, are best supported with or in software or integrated circuits (ICs), such as a digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

In addition to devices of a general nature with signal processing capability, the communication units, communication networks, devices, and the like of particular interest are those providing or facilitating voice communications services over cellular wide area networks (WANs), such as conventional two way systems and devices, various cellular phone systems including analog and digital cellular, CDMA (code division multiple access) and variants thereof, GSM, GPRS (General Packet Radio System), 2.5 G and 3 G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof. Furthermore the wireless communication networks of interest may have short range wireless communications capability normally referred to as WLAN capabilities, such as IEEE 802.11, Bluetooth, or Hiper-Lan and the like preferably using CDMA, frequency hopping, OFDM or TDMA access technologies and one or more of various networking protocols, such as TCP/IP (Transmission Control Protocol/Internet Protocol), UDP/UP (Universal Datagram Protocol/Universal Protocol), IPX/SPX (Inter-Packet Exchange/Sequential Packet Exchange), Net BIOS (Network Basic Input Output System) or other protocol structures. Alternatively the wireless communication networks of interest may be connected to other networks such as a LAN using protocols such as TCP/IP, UDP/UP, IPX/SPX, or Net BIOS via a hardwired interface such as a cable and/or a connector.

As further discussed herein below, various inventive principles and combinations thereof are advantageously employed to provide an increase in signal quality, e.g. SNR or SINR in a device, such as a communication unit equipped with a vocoder, signal processor, signal processor implementing a vocoder or the like, for processing speech signals. In accordance with various exemplary embodiments, the signal quality can be improved, for example, SNR or SINR can be increased, meaning noise and interference can be reduced prior to vocoding, in order to improve vocoding quality, by determining to which of several classifications an input signal belongs. Classifications include classification of the input signal as periodic and mixed periodic plus noise combined with interference, which may be classified as periodic, noise, or mixed periodic plus noise. Thus the possible classifications for an input signal, which is presumed to at least contain a signal component plus an interference component, include: the signal component includes mixed periodic energy plus noise energy and the interference component includes mixed periodic energy plus noise energy; the signal component includes mixed periodic energy plus noise energy and the interference component includes periodic energy; the signal component includes mixed periodic energy plus noise energy and the interference component includes noise energy; or the signal component includes periodic energy and the interference component includes noise energy.

One requirement to successfully process input signals for the case where both the signal and the interference are mixed periodic plus noise signals is that the desired signal is a degree more wide-sense stationary than the interference signal or signals, and that the interference is a degree more uncorrelated than the desired signal. As will be appreciated by one of ordinary skill in the art, the term wide sense stationary refers to a signal X(t), characterized mathematically in a typical receiver as a random process, having a mean which is constant for all t and an autocorrelation depending only on τ=t₂−t₁.

Advanced Multi-Band Excitation (AMBE+2) vocoders are currently being evaluated for implementation, for example, in integrated digital enhanced networks such as are available from providers, such as Motorola, Inc. The AMBE+2 vocoder is a parametric vocoder which achieves a high rate of compression, and consequently operates with low bit rates of 4400 and 2200 bits per second, for example. An encoder in the AMBE+2 vocoder executes a set of analysis algorithms which determine a set of parameters for a given time interval or window of samples. The parameters are transmitted through the communications system with error correction/detection coding, interleaving, and other measures to counter bit errors. At the receiving end, the decoder reconstructs the speech or single or dual tones using the parameters. Ignoring the effects of the communications network, and assuming perfect transmission and reception of the vocoder parameters, the performance of vocoder analysis may be increased or improved using the inventive concepts discussed and described herein.

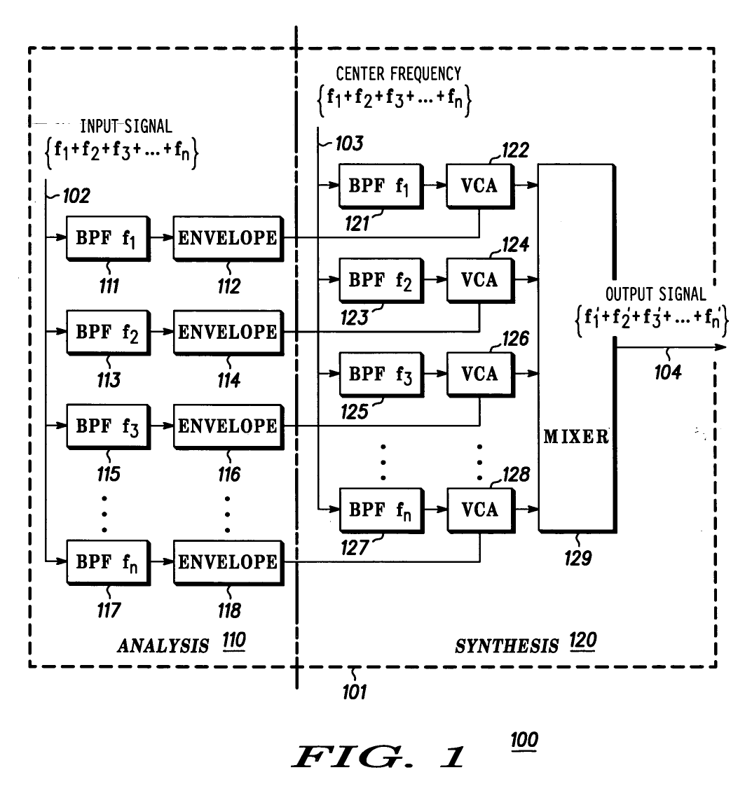

To better understand these inventive concepts, a brief discussion of voice coders or vocoders will be helpful. Vocoders were originally developed as an efficient means of transmitting and re-transmitting voice signals via telephone lines which can typically be characterized as highly band limited channels. As shown in diagram 100 of FIG. 1, exemplary vocoder 101 may include analysis section 110 and synthesis section 120 for analyzing a voice signal or any signal within the voice band by breaking down, for example input signal 102 into a series of adjacent frequency bands f₁+f₂+f₃+ . . . +fₙ, and then using respective amplitudes of the frequency bands to synthesize an output signal as will be described in greater detail.

Input signal 102, which may be a speech signal, an audio signal, or the like, having energy within the voice band is fed through a series of bandpass filters 111, 113, 115, and 117. It will be appreciated that since voice frequencies are typically band limited, generally between, say, 250 Hz and 4000 Hz, or at least contain most of their energy and thus information in this frequency band, transmission channels for carrying voice are also typically band limited or at least are not expected to provide favorable transmission characteristics outside these frequency limits. While typical human hearing is capable of discriminating tones from a few hertz to around 20,000 Hz, such fidelity is generally not required for successful speech recognition and, as noted, cannot readily be achieved over normal communication channels. It will be appreciated however, that the methods described herein can be used in a variety of applications with relatively narrow or relatively wide frequency bands.

Bandpass filters 111, 113, 115, and 117 are centered at frequencies f₁+f₂+f₃+ . . . +fₙ spaced one-quarter to one-half octave apart. Taken together, the filter bands are preferably configured to cover most of the speech related audio spectrum, for example, as noted above. Thus, each of bandpass filters 111, 113, 115, and 117 will pass a time variant signal proportional to the energy contained in respective frequency bands f₁+f₂+f₃+ . . . +fₙ to respective envelope followers 112, 114, 116, and 118. A corresponding control voltage proportional to the envelope of the output of the respective bandpass filter is input to Voltage Controlled Amplifiers 122, 124, 126, and 128. It will be appreciated by one of ordinary skill in the art that the envelope of the bandpass is simply the real time amplitude of the in-band signal energy for the respective frequency band of the filter. The output of each respective envelope follower 112, 114, 116, and 118 is a control signal representing the level of energy of input signal 102 in respective frequency bands at any time. Thus the output of analysis section 110 is a set of varying control voltages representing a real time analysis of the frequency components of input signal 102.

The voltage outputs of envelope follower 112, 114, 116, and 118 are fed to synthesis section 120 of vocoder 101 where they are input to voltage controlled amplifiers (VCA) 122, 124, 126, and 128 respectively as noted. It will be appreciated that in order to recreate input signal 102, a set of bandpass filters 121, 123, 125, and 127, identical to bandpass filters 111, 113, 115, and 117 of analysis section 110, are fed by a second signal such as a carrier, or excitation signal 103 with energy centered at frequency bands f₁+f₂+f₃+ . . . +fn. Since the carrier preferably has constant energy across the speech signal spectrum, VCAs 122, 124, 126, and 128 are used to modulate the output of bandpass filters 121, 123, 125, and 127. The outputs of VCAs 122, 124, 126, and 128 may be combined or mixed, for example, in mixer 129 to generate audio output 104, which should be a close facsimile of input signal 102.

Thus an exemplary parametric vocoder such as vocoder 101 described above, in accordance with various exemplary embodiments, can be configured or can be supported by external processing to better encode a set of digitized speech samples by inputting speech samples in which the SINR has been increased. Such SINR increase can be accomplished by performing a preliminary analysis to determine certain properties of the set of digitized speech samples, such as determining the character of noise, tone, or speech. The initial analysis may be used to form the basis of subsequent analysis and decision making regarding, for example, which of the classifications noted above the signal falls into. Accordingly, an output from one of a series of adaptive filters may be selected resulting in the most favorable SNR or SINR for the input signal or, if more favorable, the unfiltered signal may be passed, as will be described in greater detail hereinafter.

When a set of speech samples associated with an input signal to be analyzed has a low Signal-to-Interference plus Noise Ratio (SINR), the interference plus noise can degrade the initial analysis in the vocoder, such as analysis section 110, by causing errors regarding the properties of the digitized speech samples. By degrading the quality of the initial analysis which determines the properties of the speech including the interference and noise, the subsequent parameters may be assigned in error, for example during synthesis by the synthesis section 120, and the parameters arrived at during analysis may be wholly irrelevant when compared to the correct set of parameters that would be necessary to properly encode the digitized speech samples if correctly characterized or classified. The resulting synthesis error leads predictably to poor audio quality. Thus in accordance with various exemplary embodiments, the SINR may be increased, consequently decreasing the probability that a wrong decision regarding the properties of the input signal will be made and improving the overall performance of and quality of synthesized speech output from a speech processor, encoder, vocoder, or the like.

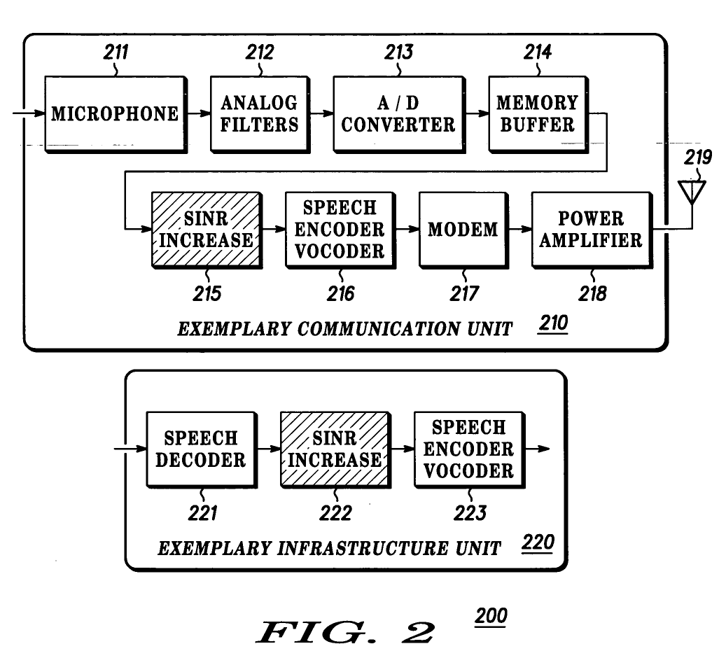

Referring to FIG. 2 and block diagram 200, the placement of exemplary blocks 215 and 222 for increasing SINR and reducing noise is discussed and described. Communication unit 210, which, as noted above, can include a wireless subscriber device such as a wireless handset or the like, or other devices as described herein, is equipped with block 215 for increasing SINR. Block 215 may be located before speech encoder or vocoder 216 to increase SINR prior to encoding. As will be appreciated by one of ordinary skill in the art, speech may be generated in communication unit 210 by microphone 211 which can be a microphone or other audio transducer as is known. The output of microphone 211 is input to a series of analog filters 212 for initial processing of the voice signal prior to conversion in A/D converter 213. Samples generated in A/D converter 213 may be stored in a memory or buffer 214 preferably for an entire frame worth of speech. As noted, speech samples are processed or otherwise acted upon in block 215 to reduce SINR as will be described in greater detail, for input to speech encoder or vocoder 216 which then outputs encoded speech to MODEM 217. The modulated output signal from MODEM 217 is input to Power Amplifier 218 for amplification and transmission over the air interface using antenna 219.

In exemplary infrastructure unit 220, which may be, for example, a transcoder or the like, block 222 may be used to increase SINR associated with speech samples decoded by speech decoder 221, such as from a foreign network. SINR increased samples may be input to speech encoder or vocoder 223 for continued transmission within the infrastructure or output to a communication unit as will be appreciated by one of ordinary skill in the art.

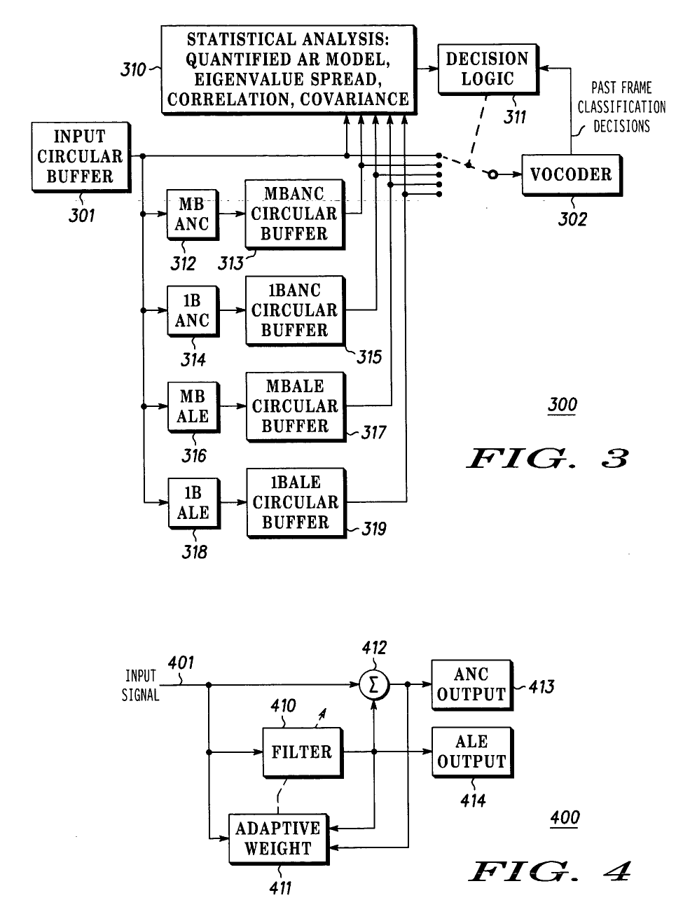

Referring to FIG. 3, a detailed diagram associated with the increase of SINR performed, for example, in blocks 215 and 222 above is discussed and described. SINR increase is accomplished in accordance with various exemplary embodiments, by selection of a favorable or optimum one or possibly more signals from among a set of filtered signals and including the unfiltered signal using a criteria such as by comparing the output from a filter having a classification associated with the filter matching an actual classification of the input signal, or the like. The criteria may be used to determine which of the signals will result in the best or in an optimized SINR, using, for example, statistical analysis in block 310 of the filtered and unfiltered speech samples. In addition to analysis of the unfiltered signal and filtered versions thereof, feedback associated with previous vocoder speech frame classifications may also be used. It will be appreciated that classifications include identification and characterization of the probable sources of signal, noise, and interference. The input signal includes a signal component and an interference component and each component may be further classified as periodic, noise, or mixed periodic plus noise. As noted above, practical scenarios that exist in the field for various signal components can include, for example, speech, DTMF tones, call progress tones, signal tones, single tones, music, and noise. Interference components can include, for example, speech, music, colored noise, automotive, motor, periodic noise (beeps, whistles, and the like), burst noise (thuds, whacks, and the like), and noise. It should be noted that by noise, reference is made to Additive White Gaussian Noise (AWGN), as noted above, which can inherent or originate in PSTN switches, from transcoding, from poor grounding, or the like.

With continued reference to FIG. 3, each of multiple filters 312, 314, 316, and 318, which are certain embodiments of adaptive filters, can optimize SINR for different signal and interference classifications. By quantifying the SINR scenarios into a discrete number of most likely classifications, for example as described above, an optimum filter may be applied for each classification. Thus, for example, adaptive filter 312 is a multi-band Adaptive Noise Cancellation (ANC) filter with an attendant circular buffer 313 which may be used to store output signal samples. During operation, adaptive filter 312 will converge to any correlated energy components and, in the case of ANC filtering, will pass only uncorrelated energy, such as energy outside the bands associated with the correlated energy components which have been converged to within the multiple bands. Adaptive filter 314 is a single band ANC filter with an attendant circular buffer 315 and as above, will pass only uncorrelated energy corresponding to energy components outside its band. Adaptive filter 316 is a multi-band Adaptive Line Enhancing (ALE) filter with an attendant circular buffer 317. During operation, adaptive filter 316 will converge to any correlated energy components and, in the case of ALE filtering, will pass only energy corresponding to the correlated energy components which have been converged to within the multiple bands. Adaptive filter 318 is a single band ALE filter with an attendant circular buffer 319 and, as above, will pass only energy corresponding to correlated energy components within its band.

Statistical analysis may be performed in statistical analysis block 310 on pre or post filtered speech samples, for example from circular buffer 301 which contains prefiltered input speech samples and circular buffers 313, 315, 317, and 319 which contain post filtered speech samples. In addition, statistical analysis block 310 can use feedback from previous vocoder classifications and statistical analysis results stored in a memory such as in an attendant signal processor or the like as would be known to one of ordinary skill. Statistical analysis block 310 and decision block 311 may be used to determine the highest probable match of the actual signal and thus SINR scenario with whatever one of adaptive filters 312, 314, 316, or 318 generates the most favorable results including none of the filters such that the unfiltered speech or signal samples are used. For example, in the case where a high quality speech signal is being processed with little or no noise or interference, it may be preferable to pass the signal unprocessed since processing, for example, through an ANC filter may distort specific frequency components. Thus samples from whatever source results in the highest SINR may be selected and routed to vocoder 302 for encoding.

To better understand the adaptive filters described herein above, reference is made to FIG. 4 where a single band adaptive filter is illustrated in block diagram 400. The single band adaptive filter may be used, for example, to remove a periodic interference source as will be appreciated by one of ordinary skill. Input signal samples, such as from input circular buffer 301 described above, are input at input node 401 coupled to adaptive filter block 410, adaptive weight generating block 411, and summation node 412. Output from adaptive filter block 410 is coupled as feedback to adaptive weight generating block 411, to summation node 412, and to ALE output block 414. The output of summation node 412 is coupled to ANC output block 413 and is also fed back to adaptive weight generating block 411 as a feedback signal. It will be appreciated that all or selected portions of the elements illustrated in scenario 400 of FIG. 4 may be implemented in a variety of ways including in circuitry, in a software program being executed using a general purpose processor, in a digital signal processor, or the like.

To address the variety of additional classifications possible for the signal component and the noise component of the input signal, a multi-band adaptive filter is shown in FIG. 5. Therein exemplary block diagram 500 includes elements for processing samples associated with an input signal. Input samples may be coupled to filter bank 1 501, filter bank 2 502, up to filter bank n 503. It will be appreciated that individual filter banks 501, 502, and 503 may be used to separate individual frequency bands from the input signal samples and output the frequencies of interest to respective adaptive filter section 1 510, adaptive filter section 2 512, and adaptive filter section n 514. Each of filter banks 501, 502, and 503 may be any of a variety of analysis filter banks including Discrete Fourier Transform (DFT), or Quadrature Mirror Filters (QMF). It will be appreciated that for each frequency band, an ANC and an ALE filter output can be generated depending on whether the energy is desired or undesired. For example, the energy in the input signal for adaptive filter section 1 510 may contain a periodic interference component and/or a periodic signal component. Adaptive filter section 1 510 is capable of being configured as both an ANC and an ALE and thus can either enhance the energy if it is associated with a signal component or can cancel the energy if it is associated with a noise or interference component. The ANC and ALE outputs from adaptive filter section 1 510, adaptive filter section 2 512, and adaptive filter section n 514 can be input respectively to filter bank 1 511, filter bank 2 513, and filter bank n 515, which can also be any of a variety of synthesis filters such as Inverse Discrete Fourier Transform (IDFT) filters, Quadrature Mirror Filters (QMF) or the like for reducing aliasing and performing other filtering functions in the band of interest. The outputs from filter bank 1 511, filter bank 2 513, and filter bank n 515 are progressively summed in summation nodes 505 and 504 and the aggregate filtered signals are output as ANC output 506 and ALE output 507.

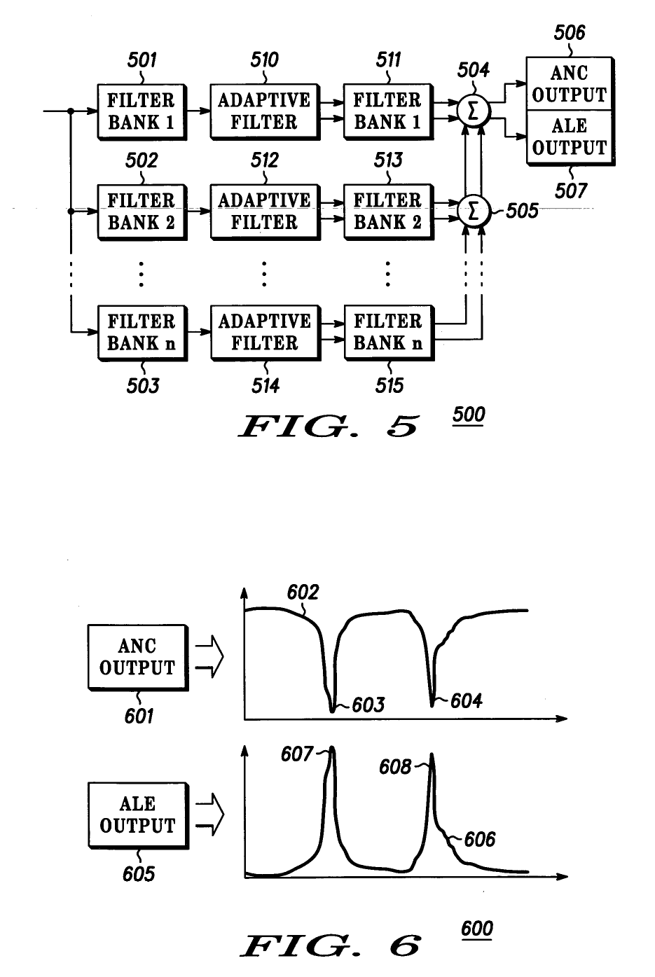

Exemplary response graphs are illustrated in FIG. 6 for ANC output 601 and ALE output 605, which can represent multi-band ANC output 506 and ALE output 507 respectively or single band ANC output 413 and ALE output 414 respectively. ANC output 601 shows response 602 including notches 603 and 604 where the energy associated with the center frequency of the notch is attenuated or cancelled. Any noise, periodic interference, or undesirable energy within notches 603 and 604 will be attenuated. ALE output 605 shows response 606 including peaks 607 and 608 where the energy not associated with the center frequency of the peaks is attenuated or cancelled. Any desirable signal energy within peaks 607 and 608 will thus be emphasized and enhanced relative to the undesirable energy. Both ANC output 601 and ALE output 605 can represent an increased SINR for signal component energy enhanced, for example, by ALE filtering and from which noise and interference components have been attenuated by, for example, ANC filtering. Once ANC and ALE outputs are generated, analysis can proceed to determine which of the classifications the input signal falls into and thus, which filter bank will produce the greatest increase in SINR.

As is appreciated by those of ordinary skill in the art, several statistical analysis techniques are available to determine the effectiveness of adaptive filtering on various configurations corresponding to signal component plus noise component classifications. One or more statistical analysis methods, as may be performed for example by block 310 shown in FIG. 3 and discussed herein above, may be used separately or in combination to analyze at a minimum, pre-filtered digitized speech samples, such as from input circular buffer 301 and also to analyze the filtered output of adaptive filters 312, 314, 316, and 318 of FIG. 3 or adaptive filters 510, 512, and 514 of FIG. 5. Statistical analysis may include measuring the eigenvalue spread, Auto-regressive (AR) modeling, correlation, covariance, and the like. As previously noted, feedback from analysis and classification for previous sets of speech samples are used to weight the decision generated, for example, in decision block 311. Thus by performing statistical analysis using decision feedback and weighting results, a new decision may be formed to select a filter through which to route speech samples and thus SINR can be increased.

It should be noted that the operating conditions of the parametric speech encoder are preferably classified into several scenarios of signal-to-interference-plus-noise. These scenarios are considered as the complete set of potential operating conditions. A corresponding adaptive filter, which may be multi-band or single band, and in certain embodiments operates at the speech sampling rate of 4 K samples/second or, a multi-band filter, the rate converted by the filter banks, is implemented for each quantified operating condition. Statistical analysis is performed on the input and output of each adaptive filter. Data generated during statistical analysis, in combination with feedback data from a classification or classifications associated with the previous vocoder frame or frames, is used to form a decision as to the best adaptive filter selection to be used as input for the vocoder in terms of SINR among either the filtered output signals from the adaptive filters or from unfiltered speech samples.

As noted, the input signal includes a signal component and an interference component and, when considered in terms of the different types of possible contents of the signal and interference components, the classifications of the input signal including the signal component and the interference component include: 1) the signal component includes mixed periodic energy plus noise energy and the interference component includes mixed periodic energy plus noise energy; 2) the signal component includes mixed periodic energy plus noise energy and the interference component includes periodic energy; 3) the signal component includes mixed periodic energy plus noise energy and the interference component includes noise energy; and 4) the signal component includes periodic energy and the interference component includes noise energy. It is important to note that, ideally, the signal component is of interest and is sought to be recovered from the combined signal plus interference signal. Thus in cases where both the signal component and the interference component are both periodic, it will be difficult to distinguish between the signal and the noise and consequently no adaptive filter can be configured for such a case or any case where the interference is determined to have a periodic component.

Adaptive filters can be used to isolate correlated signal components from uncorrelated input signal components. Depending on individual properties of the signal component and the interference component of the input signal, different adaptive filter structures for the filters described herein above can be used to increase the SINR. Moreover, if an input signal can be, for example analyzed and classified into one of the following categories based on the nature of the signal component and the interference component, an adaptive filter specially configured to address the particular characteristics of the category can be selected and an output signal associated with the selected adaptive filter may be input to a vocoder or the like.

Thus in accordance with various exemplary embodiments, the following classifications or categories will be discussed. The case where the signal component includes mixed periodic energy plus noise energy and the interference component includes mixed periodic energy plus noise energy is quite prevalent and is a difficult case to correct for. One of two requirements for analyzing and correcting such a case includes that the signal component is a degree more wide-sense stationary than the interference component, and the interference component is a degree more uncorrelated than the signal component. If these conditions are met, an optimum structure of the ALE type adaptive filter can be determined and implemented, for example a wideband ALE filter, consisting of multiple narrow bands. Alternatively if the signal component is a degree less wide-sense stationary that the interference component, and the interference component is a degree more correlated than the signal component, an optimum structure of the ANC type adaptive filter can be determined and implemented, such as a wideband ANC filter consisting of multiple narrow band ANC filters as will be described in greater detail hereinafter.

The case where the signal component includes mixed periodic energy plus noise energy and the interference component includes periodic energy is a scenario where analysis and adaptive filtering is likely to achieve a favorable result. Since the interference component contains only periodic energy, the correlation properties of the interference signal are good and therefore an adaptive filter configured for this classification can effectively isolate the stationary elements of the signal+interference. A single-band (300 Hz-3.3 kHz) adaptive noise canceller (ANC) can be applied to form a band-stop notch filter. This passes the desired signal of speech while attenuating single and dual tones.

The case where the signal component includes mixed periodic energy plus noise energy and the interference component includes noise energy requires the desired signal—the periodic energy—of the signal component to be a degree more wide-sense stationary than the interference component. Further, the interference component should be a degree more uncorrelated than the desired signal. Since the interference component for this case includes primarily noise, and the desired signal is correlated, the signal can be assumed to have better correlation properties than the interference. Therefore, an ALE filter can be used to isolate and enhance the signal. An optimum ALE adaptive filter structure such as a wideband ALE, such as a multiband structure with multiple narrowband filters will be appropriate in many embodiments.

In the case where the signal component includes primarily periodic energy and the interference component includes primarily noise energy, a well documented favorable result can be achieved. Since the signal component consists of periodic energy associated with a desired signal, it has good correlation properties. An exemplary adaptive filter can effectively isolate the stationary elements of the signal component from the noise energy associated with the interference component. For example, a single-band adaptive line enhancer (ALE) filter with an operating band of around 300 Hz-3.3 kHz can be applied to form a band-pass notch filter passing the desired signal or tones while attenuating noise or interference.

Thus, the possible characteristics of the signal component and the noise component of an input signal can be characterized into a set number of cases where the noise and interference can be reduced even though the actual properties of the signal and interference are not known a priori. An optimum or appropriate structure for an adaptive filter for each scenario of signal and interference can be constructed, and certain parameters can be used to make a decision on the best set of input samples to be passed to, for example a vocoder. The decision logic can operate on the statistical properties of the adaptive filter outputs, the statistical properties of the unfiltered input samples, and feedback of past vocoder decisions on frame type. The statistical data gathered on the filtered and unfiltered speech samples can be obtained from Auto-Regressive (AR) modeling, eigen-analysis, correlation and covariance measurement or other signal processing techniques that can quantify the signal component plus interference component correlation properties. Since adaptive algorithms typically minimize the mean-square error based on correlation methods such as least mean square (LMS) or covariance methods such as recursive least squares (RLS), or variants thereof, such metrics are useful in determining the adaptive filter characteristics for the several defined signal, interference and noise input signal scenarios described above. The decision logic in decision block 311 controls the routing of speech samples, or may by-pass the adaptive filters if a decision to use an output from one of the adaptive filters is determined to be non-beneficial to the SINR.

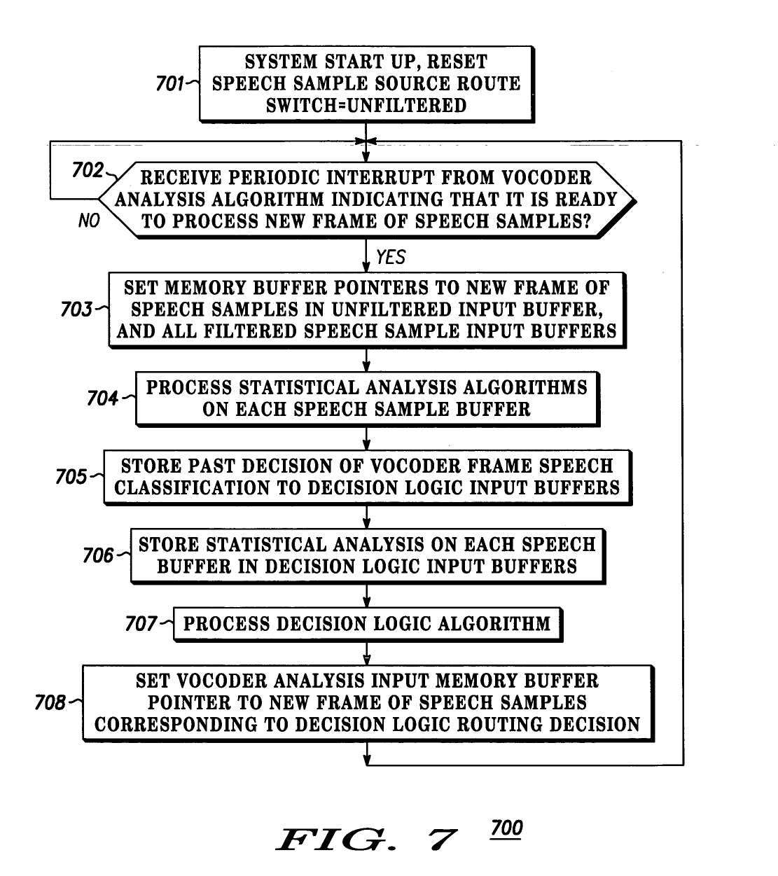

An exemplary procedure for use in processing signal samples in accordance with various exemplary embodiments is shown in FIG. 7 and will be discussed and described herein below. At system start-up at 701, the processing may be in a reset state where adaptive filtering is disabled and only unfiltered samples are passed through to the vocoder. When it is determined in, for example, 702, that an interrupt has been received the vocoder is ready for a new frame of speech samples. Accordingly, memory, for example, in circular input buffer 301 and in filter circular buffers 313, 315, 317, and 319 are set to a new frame beginning at 703. Statistical analysis is then performed on speech samples in all of the buffers at 704. Past frame classification decision is stored in decision logic buffers at 705 for use in, for example, the next iteration of processing. Statistical analysis results may also be stored in the decision logic input buffer at 706. Once all information associated with current frame samples and past frame sample analysis is in place in respective buffers decision logic may be processed at 707. Based on the result of the decision logic, a pointer may be set at 708 to the set of samples corresponding to the decision as to which buffer to read from for input to the vocoder.

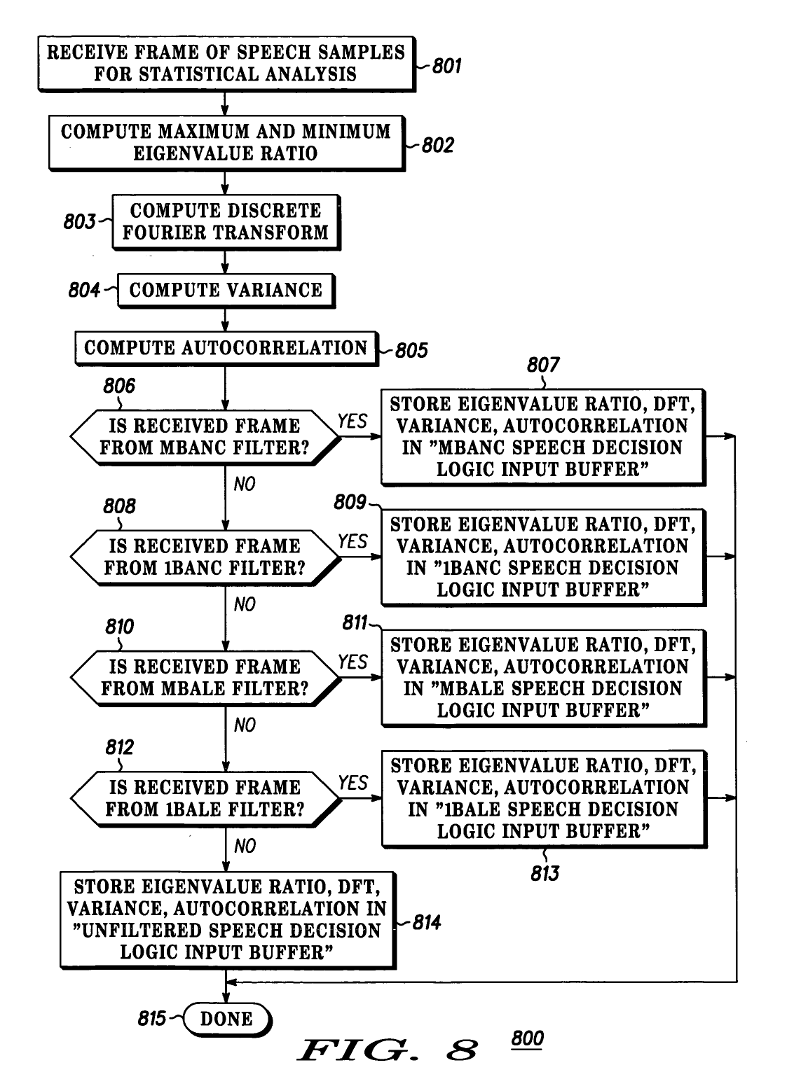

With reference to FIG. 8, an exemplary procedure for statistical analysis is discussed and described. It is noted that the exemplary procedure for statistical analysis is performed individually on frames of samples from all filtered speech buffers, and the unfiltered speech buffer, and the results stored in an input buffer to the decision logic corresponding to the source of the speech samples used in the statistical analysis. As will be appreciated by one of ordinary skill, statistical analysis is performed on a frame of input samples at 801 and can include a variety of individual methods. For example, the ratio of minimum and maximum eigenvalue is computed at 802, Discrete Fourier Transform (DFT) is computed at 803, variance associated with input samples is computed at 804, and autocorrelation associated with input samples is computed at 805. At 806 it is determined whether the statistical analysis in 802-805 was performed on the multi-band ANC filtered speech samples. If so, results of 802-805 are stored in decision logic input buffers associated with the multi-band ANC adaptive filter at 807 for generating decision history data at which point the procedure is done at 815. Alternatively, the procedure can continue to determine whether if at 808 the statistical analysis in 802-805 was performed on the single-band ANC filtered speech samples. If so, results of 802-805 are stored in decision logic input buffers associated with the single band ANC adaptive filter at 809 for generating decision history data at which point the procedure is done at 815. As before, rather than terminating, the procedure can continue to determine whether if at 810 the statistical analysis in 802-805 was performed on the multi-band ALE filtered speech samples. If so, results of 802-805 are stored in decision logic input buffers associated with the multi-band ALE adaptive filter at 811 for generating decision history data at which point the procedure is done at 815. As before, rather than terminating, the procedure can continue to determine whether if at 812 the statistical analysis in 802-805 was performed on the single-band ALE filtered speech samples. If so, results of 802-805 are stored in decision logic input buffers associated with the single band ALE adaptive filter at 813 for generating decision history data at which point the procedure is done at 815. If no single band ALE filtering has been performed then results of 802-805 are stored in decision logic input buffers associated with the unfiltered speech samples at 814 for generating decision history data at which point the procedure terminates at 815.

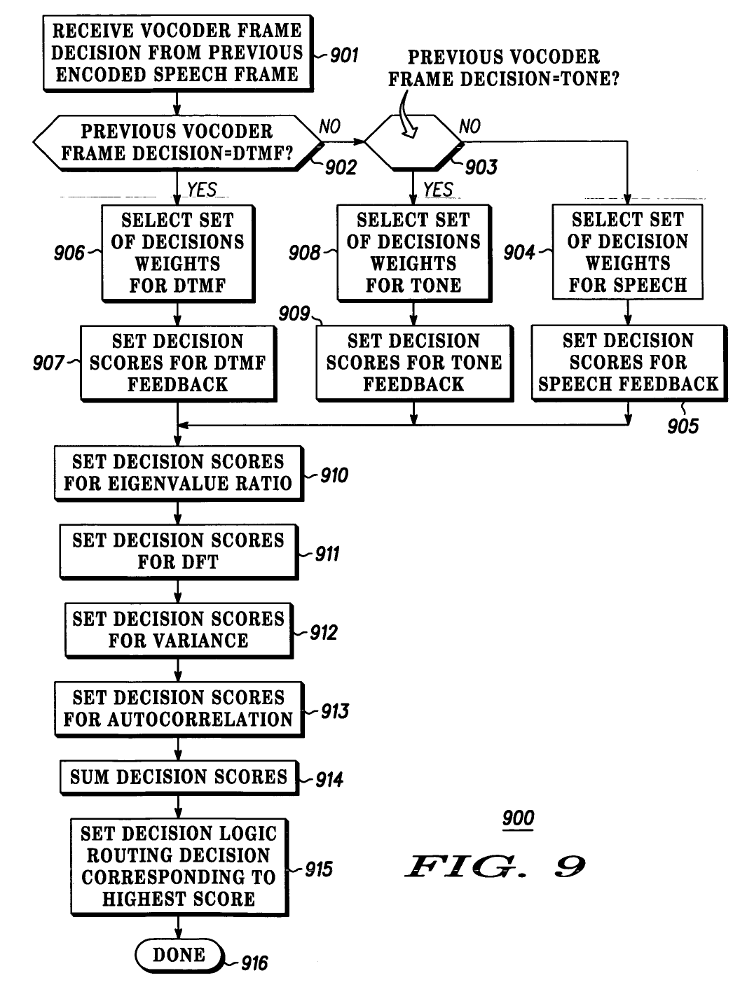

With reference to FIG. 9, process 900 includes an exemplary procedure associated with decision logic in accordance with various exemplary embodiments. At 901 the decision made for the previous frame of samples is received. The previous decision is checked at 902 to determine whether the decision was that the samples represented, for example, Dual Tone Multiple Frequency (DTMF) tones as would be appreciated by one of ordinary skill in the art. If it is determined that the previous decision was not DTMF, the previous decision is checked to determine whether the decision was that the samples represented, for example, a TONE at 903. If the decision was not TONE, then the current decision weights are set to SPEECH at 904 and decision scores are set for speech feedback at 905. If the previous decision is determined at 902 to be DTMF, then the current decision weights are set to DTMF at 906 and the decision scores are set for DTMF feedback at 907. If the previous decision is determined at 903 to be TONE, then the current decision weights are set to TONE at 908 and the decision scores are set for TONE feedback at 909. At 910, the decision scores are set for eigenvalue ratio, at 911 for DFT, at 912 for variance, at 913 for autocorrelation, and at 914 the decision scores are summed. At 915, the highest score after summing will be set as the routing decision at which point the procedure for the present frame terminates at 916 or simply loops or waits for the next frame.

Thus, each SINR scenario is given an overall score, based on the set of weighted inputs from the statistical analysis. A particular weight is used for each type of statistical analysis. For example, for the signal component plus interference component as noted above where the signal component includes mixed periodic energy plus noise energy and the interference component includes periodic energy; or where the signal component includes periodic energy and the interference component includes noise energy, the DFT may be given a higher weight than the AR model in the statistical analysis and scoring or weighting. All of the scores for each type of analysis are computed and summed for each scenario. The highest score determines the best adaptive filter and corresponding sample buffer from which samples are routed to the vocoder. Thus for each possible routing scenario such as: bypass, adaptive filter 1, adaptive filter 2, adaptive filter 3, and adaptive filter 4, the AR model is assigned an AR weight and corresponding AR score, the eigenvalue model is assigned an eigen weight and an eigen score, the correlation model is assigned a correlation weight and a correlation score, the covariance model is assigned a covariance weight and a covariance score, the DFT model is assigned a DFT weight and a DFT score, and the feedback model is assigned a feedback weight and a feedback score. The score total is then calculated and the routing decision made based thereon.

For each scenario, the value multiplied by the weight equals the score for a particular statistical parameter. The AR model multiplied by the AR weight equals the AR score, the eigenvalue multiplied by the Eigen weight equals the Eigen score, the correlation multiplied by the correlation weight equals the correlation score, the covariance multiplied by the covariance weight equals the covariance score, and the feedback multiplied by the feedback weight equals the feedback score. The total scenario score is then calculated.

Thus an exemplary AR score value determination, can proceed according to the following steps: 1) model the next block speech samples that will be sent to the vocoder input from the 5 sources, input sample buffer, and 4 output buffers from multi-band (narrow band)-ANC, single band (wideband)-ANC, multi-band (narrow band)-ALE, single band (wideband)-ALE filters. The AR model is a set of filter coefficients that will model the envelope of the speech given white noise stimulus, 2) the filter coefficients are matched to a look-up-table of AR models (coefficient sets) that are known to represent one of the four SINR scenarios, 3) use the error between the coefficients to calculate a “soft output” for each scenario, 4) multiply the soft decision by the weight parameter for each SINR scenario where the weight is programmed by the user to allow different AR analysis weighting for each SINR scenario, and 5) store the final score for each SINR scenario.

An exemplary eigenvalue score value determination can proceed according to the following steps: 1) compute an eigenvalue spread on the input correlation matrix for the next block speech samples that will be sent to the vocoder input from the 5 sources, input sample buffer, and 4 output buffers from multi-band (narrow band)-ANC, single band (wideband)-ANC, multi-band (narrow band)-ALE, single band (wideband)-ALE filters where large eigenvalue spreads indicate a measure of “stationarity” of the set of samples, 2) use the Eigenvalue spread value to calculate a “soft output” for each scenario, 3) multiply the soft decision by the weight parameter for each SINR scenario, where the weight is programmed by the user to allow different Eigenvalue analysis weighting for each SINR scenario, and 4) store the final score for each SINR scenario.

An exemplary feedback score value determination can proceed according to the following steps: 1) calculate weights for each SINR scenario based on other statistical parameters already calculated, for example if the last frame was determined to be a tone, and the DFT and eigen analysis indicate a presence of a tone, then the value for feedback for scenarios 1, 2, and 3, each of which including a signal component having mixed periodic energy plus noise energy, can be given a low score, while scenario 4, which includes a signal component having periodic energy, can be given a high score, 2) multiply the soft decision by the weight parameter for each SINR scenario where the weight is programmed by the user to allow different feedback weighting for each SINR scenario, and 3) store the final score for each SINR scenario.

All final scores are added up for each SINR scenario, and then the scenario totals are added. The highest score is used to make a decision on the routing of speech samples going into the vocoder. It will be appreciated that while the above description provides usefulness in increasing SINR, additional development for finding the optimum adaptive filter scheme for signal component plus interference component scenario 1 and 3 are needed along with improved ways to detect the stationary properties of the signal component plus the interference component.

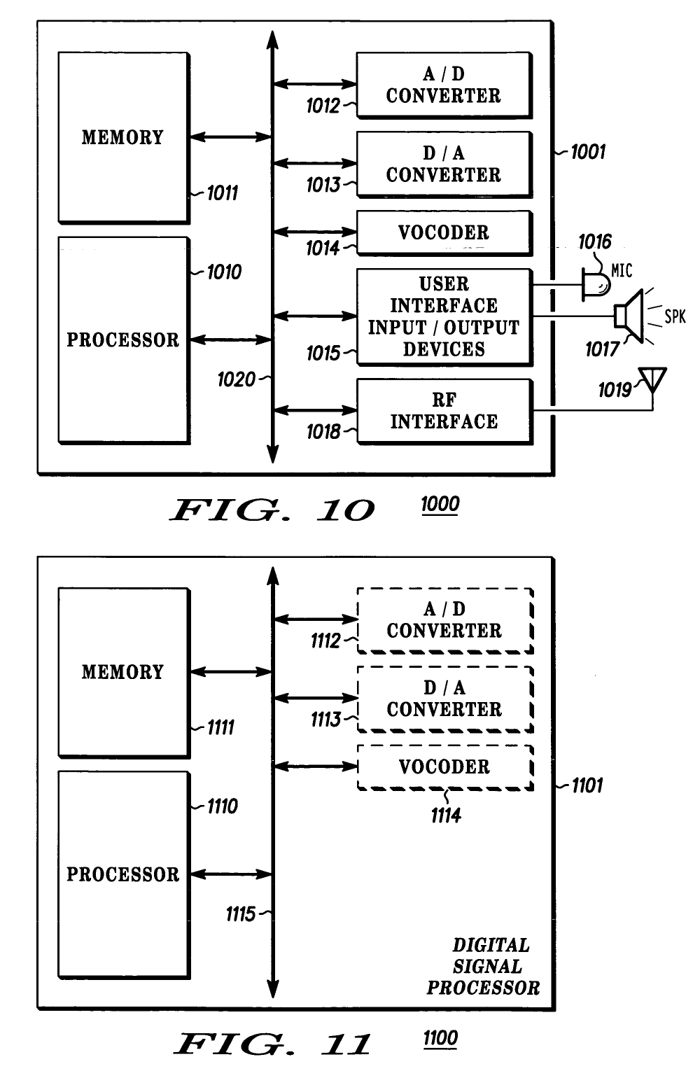

It will be appreciated that the above described procedures and techniques can be used to increase SINR in an apparatus such as exemplary device 1001 as shown in FIG. 10 which may be an exemplary communication unit such as a wireless handset, an exemplary infrastructure component such as a transcoder, or the like. Device 1001 includes a processor 1010 and a memory 1011 which can be any one of a variety of Random Access Memory (RAM) devices as would be well known to one of ordinary skill. Device 1001 can also include Analog to Digital (A/D) converter 1012 for producing digital samples of analog signals such as might originate, for example, from microphone 1016 and a Digital to Analog (D/A) converter 1013 for producing analog signals from digital samples. Device 1001 can further include vocoder 1014 as one or more separate devices and, if device 1001 is embodied as an infrastructure component, the present invention may provide increased SINR during transcoding, which involves decoding and re-encoding digital samples from differently configured vocoders. Device 1001, particularly in the case of a communication unit such as a wireless handset preferably includes user interface 1015 for displaying information and for collecting input from input devices such as microphone 1016 and for generating output to output devices such as audio transducer 1017 which can be, for example, a speaker or the like. In addition, device 1001 can include RF interface 1019 for transmitting and receiving signals over an air interface associated with for example a wireless, cellular, radio or other communication system or wireless network. It will also be appreciated that all of the above identified elements can be connected using bus 1020 which can be one or a combination of a parallel bus and a serial network connection, or other serial interconnection such as a Universal Serial Bus (USB) or the like as would be well known and appreciated by one of ordinary skill in the art.

In accordance with still other exemplary embodiments, the above described procedures and techniques can be used to increase SINR in a dedicated processor such as exemplary digital signal processor (DSP) device 1101 as shown in the block diagram 1100 of FIG. 11. DSP device 1101 includes an arithmetic or processing unit 1110, a memory 1111, and optionally A/D converter 1112, D/A converter 1113 and vocoder 1114. DSP device 1101 can process digitized speech samples whether from A/D converter 1112 or from another component within an exemplary architecture and transferred to DSP device 1101 over, for example, bus 1115 to which all the above noted elements can be connected. Bus 1115 is preferably a parallel bus for accommodating high speed processing but may also include, at least in part, a serial data connection such as a network connection, a serial bus or serial to parallel bus interface, such as a USB as would be well known to one of ordinary skill in the art.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method for increasing a signal quality, the method comprising:
analyzing an input signal and a plurality of output signals output from a plurality of adaptive filters into which the input signal is input, the plurality of adaptive filters associated with a plurality of predetermined classifications associated with the signal quality, the analyzing to determine an actual classification of the input signal; and
selecting one of: one of the plurality of output signals, and the input signal based on the analyzing to provide a selected one which results in a value of the signal quality associated with an output signal generated based on the analyzing and the selecting.

2. A method in accordance with claim 1, wherein the signal quality includes one of a Signal to Noise Ratio (SNR), and a Signal to Interference plus Noise Ratio (SINR).

3. A method in accordance with claim 1, wherein the predetermined classifications include a signal plus interference plus noise classification.

4. A method in accordance with claim 1, wherein the analyzing includes weighting the plurality of output signals from the plurality of adaptive filters and the selecting the one is based on the weighting.

5. A method in accordance with claim 1, wherein the selecting includes selecting another one of: one the plurality of output signals, and the input signal different from the selected one, which when combined with the selected one results in a value of the signal quality associated with an output signal generated based on the analyzing and the selecting.

6. A method in accordance with claim 5, wherein the analyzing includes weighting the plurality of output signals from the plurality of adaptive filters and the selecting the one and the selecting the another one are based on the weighting.

7. A method in accordance with claim 1, wherein the input signal includes a signal component and an interference component, and wherein the predetermined classifications include: the signal component includes mixed periodic energy plus noise energy and the interference component includes mixed periodic energy plus noise energy; the signal component includes mixed periodic energy plus noise energy and the interference component includes periodic energy; the signal component includes mixed periodic energy plus noise energy and the interference component includes noise energy; the signal component includes periodic energy and the interference component includes noise energy.

8. A method in accordance with claim 1, wherein the analyzing includes analyzing using statistical analysis.

9. A method in accordance with claim 1, wherein the analyzing includes analyzing using one or more of the following: quantified auto-regressive analysis, Eigenvalue spread analysis, correlation analysis, and covariance analysis.

10. A method for processing an input signal to a vocoder to increase a signal quality, the method comprising:
establishing a plurality of adaptive filters configured to adapt to a plurality of predetermined classifications associated with the signal quality;
determining an actual classification of the input signal; and
selecting at least one of a plurality of signals output from the plurality of adaptive filters based on the actual classification to obtain a value of the signal quality.

11. A method in accordance with claim 10, wherein the signal quality includes one of: a Signal to Noise Ratio (SNR) and a Signal to Interference plus Noise Ratio (SINR)

12. A method in accordance with claim 10, wherein the input signal includes a signal component and an interference component, and wherein the predetermined classifications include: the signal component includes mixed periodic energy plus noise energy and the interference component includes mixed periodic energy plus noise energy; the signal component includes mixed periodic energy plus noise energy and the interference component includes periodic energy; the signal component includes mixed periodic energy plus noise energy and the interference component includes noise energy; the signal component includes periodic energy and the interference component includes noise energy.

13. A method for processing an input signal to a vocoder to increase a signal quality, the method comprising:
inputting the input signal to a plurality of adaptive filters associated with a plurality of predetermined classifications associated with the signal quality;
analyzing the input signal and a plurality of signals output from the plurality of adaptive filters to determine an actual classification of the input signal and the plurality of signals output from the plurality of adaptive filters; and
selecting one of: one of the plurality of output signals, and the input signal which results in a value of the signal quality based on the actual classification.

14. A method in accordance with claim 13, wherein the input signal includes a signal component and an interference component, and wherein the predetermined classifications include: the signal component includes mixed periodic energy plus noise energy and the interference component includes mixed periodic energy plus noise energy; the signal component includes mixed periodic energy plus noise energy and the interference component includes periodic energy; the signal component includes mixed periodic energy plus noise energy and the interference component includes noise energy; the signal component includes periodic energy and the interference component includes noise energy.

15. A method in accordance with claim 13, wherein the analyzing includes analyzing using statistical analysis.

16. A method in accordance with claim 13, wherein the analyzing includes analyzing using one or more of the following: quantified auto-regressive analysis, Eigenvalue spread analysis, correlation analysis, and covariance analysis.

17. An apparatus for increasing a signal quality in a communication unit, the apparatus comprising:
a memory storing samples of an input signal;
a plurality of adaptive filters each configured with a possible classification for the input signal, each of the plurality of adaptive filters processing the input signal and generating a respective output signal; and
a processor coupled to the memory, the processor configured to:
determine an actual classification of the input signal;
compare the actual classification with the possible classification for the input signal; and
selecting the respective output signal of one of the plurality of adaptive filters if the actual classification matches the possible classification.

18. An apparatus in accordance with claim 17, wherein the input signal includes a signal component and an interference component, and wherein the possible classifications include: the signal component includes mixed periodic energy plus noise energy and the interference component includes mixed periodic energy plus noise energy; the signal component includes mixed periodic energy plus noise energy and the interference component includes periodic energy; the signal component includes mixed periodic energy plus noise energy and the interference component includes noise energy; the signal component includes periodic energy and the interference component includes noise energy.

19. An apparatus in accordance with claim 17, wherein the plurality of adaptive filters include an Adaptive Noise Canceling filter (ANC), and an Adaptive Line Enhancing filter (ALE).

20. An apparatus in accordance with claim 17, wherein the plurality of adaptive filters include a single band adaptive filter and a multi-band adaptive filter.

21. An apparatus in accordance with claim 17, wherein the plurality of adaptive filters includes a single band Adaptive Noise Canceling filter (ANC), a multi-band ANC filter, a single band Adaptive Line Enhancing filter (ALE), and a multi-band ALE filter.
